(19) United States
(12) Patent Application Publication
(10) Pub. No.: US 2026/0267636 A1
(43) Pub. Date: Sep. 10, 2026

(54) OPTIMIZING PROMPTS FOR LARGE-SCALE CODE MIGRATION USING ARTIFICIAL INTELLIGENCE

(71) Applicant: Google LLC, Mountain View, CA (US)

(72) Inventors: Daniele Codecasa, München (DE); Valeriya Kharatyan, München (DE); Stoyan Nikolov, Mering (DE); Alexander Frömmgen, Östringen (DE); Anna Palmqvist Sjövall, Munich (DE); Maxim Tabachnyk, Munich (DE); Jonathan Bingham, Oakland, CA (US)

(21) Appl. No.: 19/071,173

(22) Filed: Mar. 5, 2025

(51) Int. Cl. G06F 8/71; G06F 8/33

(52) U.S. Cl. CPC G06F 8/71; G06F 8/33

(57) ABSTRACT

A system receives a user query to perform at least one code migration operation on source code and provides a prompt associated with the user query as input to a first AI model trained to generate prompts for a second AI model performing code migration operations. The system obtains prompts for the second AI model from the first AI model, migrated versions of the source code for each of the first AI model’s prompts from the second AI model, and an indication of a number of predicted validation errors for the code migration operation performed by the second AI model based on the prompts. The system selects an optimized migrated version associated with a prompt upon determining that a migrated version has a lowest number of predicted validation errors. The system provides the optimized migrated version of the source code to a client device according to the user query.

### TECHNICAL FIELD

Aspects and embodiments of the present disclosure relate to user query prompts, and more specifically, to optimizing prompts for large-scale code migration using artificial intelligence.

### BACKGROUND

The development and deployment of artificial intelligence (e.g., large language models (LLMs)) has revolutionized various industries by enabling highly sophisticated natural language processing capabilities. Artificial intelligence (AI) models are trained on vast datasets and possess the ability to provide informative responses to natural language user queries. User experience and satisfaction can be impacted by the relevancy of a response from an AI model, which is based on how well the AI model can understand the initial user query and provide an expected response.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates an example system architecture in accordance with implementations of the present disclosure.

FIG. 2 depicts a flow diagram of an example method for optimizing prompts for large-scale code migration using artificial intelligence in accordance with implementations of the present disclosure.

FIG. 3 is a block diagram illustrating an example computer system in accordance with implementations of the present disclosure.

### DETAILED DESCRIPTION OF EMBODIMENTS

Aspects of the present disclosure relate to optimizing prompts for large-scale code migration using artificial intelligence (AI). A system can include one or more AI models (e.g., large language models (LLMs)) that are trained to perform various tasks associated with the system. For example, a system for code migrations (e.g., converting source code from one language to another or a new language version, updating the source code from a prior version to a current version, updating dependencies within the source code, updating an application programming interface (API), updating data types, etc.) can include one or more AI models that are trained to perform tasks relating to code migrations. A user of the system (e.g., a developer, an engineer, an operator, etc.) can provide a user query pertaining to a code migration (e.g., via a client device) and the system can provide a prompt associated with the user query as an input to the AI model(s). The provided prompt can initiate the performance of such tasks.

While AI can be leveraged to perform large-scale code migrations, the success and/or efficiency of such tasks may depend on the user query and/or the prompt provided as the input to the AI model. For example, if a user query and/or prompt references too many portions of a source code to update, the AI model may overlook areas of the source code that were not specified in the query and/or prompt, but should be updated (e.g., based on a dependency relationship with a referenced section of the source code). Further, content or instructions of a user query and/or prompt can cause inefficiencies in the code migration process. For example, if a first portion of the source code was previously updated during integration of a new API, but a second portion of the source code was not, a user query and/or prompt that instructs a global update (e.g., an update throughout the entire source code, rather than a specific portion of the source code such as a particular file) may cause the first portion of the source code to be unnecessarily updated again. This inefficiency can increase the amount of computing resources (e.g., processing cycles, memory space, etc.) consumed by the system, which makes such computing resources unavailable to other processes of the system and therefore degrades the overall efficiency and latency of the system.

Implementations of the present disclosure address the above and other deficiencies by providing optimizing prompts for large-scale code migration using AI. The present disclosure leverages a first AI model (e.g., trained to generate optimized prompts) to reduce the difficulty of prompting a second AI model (e.g., trained to perform tasks in accordance with such prompts) used in large-scale code migrations. In some embodiments, the first AI model may be trained to generate optimized prompts for the second AI model based on an initial user query. In some embodiments, a system can receive a user query from a client device to perform at least one code migration operation pertaining to source code associated with an application. In some embodiments, the code migration operations can include updating an API throughout a body of source code, translating a source code to a different language, updating the language version of the source code, updating queries for a new database scheme, updating dependencies based on library and/or framework updates, and other various large-scale changes to source code. The user query associated with the code migration operation can indicate a type of the operation that is to be performed and/or a file type and/or a particular file for which the code migration operation is to be performed.

Upon receiving the user query, the system can provide a prompt associated with the user query as an input to the first AI model and can obtain one or more outputs of the first AI model. The output(s) of the first AI model can include various prompt suggestions to be provided as an input to the second AI model (e.g., in light of the initial user query). The output(s) of the second AI model can include various migrated versions of source code for each prompt received and/or an indication of a respective migrated version that is predicted to optimize code migration at the system (e.g., in accordance with the initial user query). In some embodiments, the migrated version of source code includes an updated version of source code on which the requested code migration operation(s) has been performed. The system can identify an optimized migrated version of the source code based on the one or more outputs of the second AI model and can provide the optimized migrated version of the source code to the client device in accordance with the user query. An optimized migrated version of the source code can include a migrated version that is associated with a lowest number of predicted validation errors, in some embodiments.

Aspects of the present disclosure provide technical advantages over the above described and other deficiencies of conventional systems by providing AI-based techniques for obtaining optimized prompts for a code migration model. As the first AI model of the present disclosure is trained to predict one or more prompts associated with a code migration operation based on a given user query, the system is able to identify an optimized prompt for the second AI model without the user providing several different prompts to obtain the target result for the requested code migration operation. Accordingly, the second AI model is accessed a fewer number of times in order to perform the code migration operation, which can significantly reduce the overall amount of computing resources (e.g., processing cycles, memory space) consumed to perform the code migration operation. Further, embodiments of the present disclosure prevent the performance of duplicative code migration operations, as the first AI model can predict an optimized prompt that returns the lowest amount of validation errors and conforms with the request of the initial user query, and the second AI model, when performing code migration operations based on the optimized prompt, will not perform code migration operations to portions of the source code that have already been updated. This reduces inefficiencies and processing overhead, as only the portions of the source code that need to be updated will be included in the code migration operations.

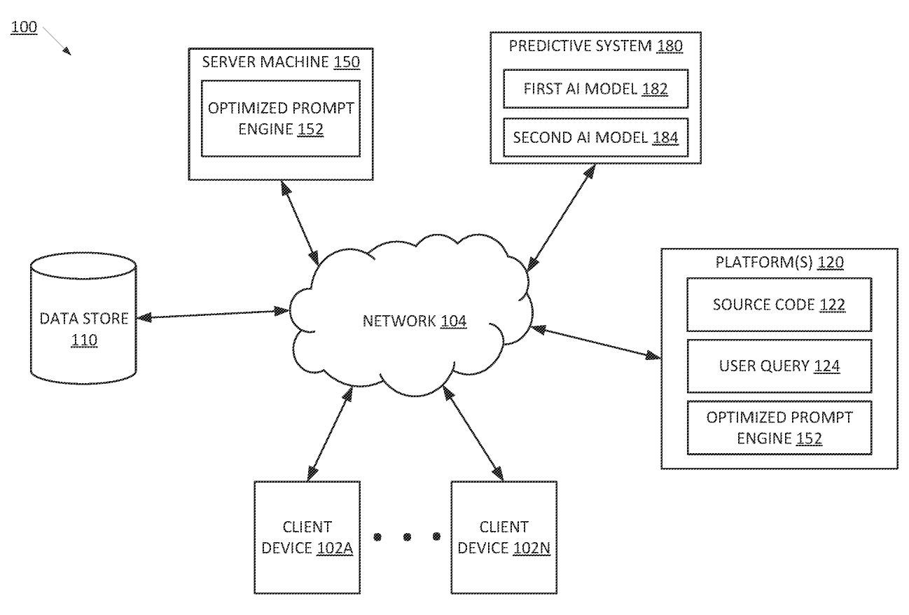

FIG. 1 illustrates an example system architecture system architecture 100 in accordance with implementations of the present disclosure. The system architecture 100 (referred to herein as system 100) includes one or more client devices 102A-N, a data store 110, a platform 120 (e.g., a code migration platform), one or more server machines (e.g., server machine 150), and/or a predictive system 180, each connected to a network 104. In implementations, the network 104 may include a public network (e.g., the Internet), a private network (e.g., a local area network (LAN) or wide area network (WAN), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, the data store 110 is a persistent storage that is capable of storing data as well as data structures to tag, organize, and index the data. Data can include (or include data of) the source code associated with an application. The data store 110 can be hosted by one or more storage devices, such as main memory, magnetic or optical storage based disks, tapes or hard drives, NAS, SAN, and so forth. In some implementations, the data store 110 can be a network-attached file server, while in other implementations the data store 110 can be some other type of persistent storage such as an object-oriented database, a relational database, and so forth, that may be hosted by the platform 120 or one or more different machines (e.g., the server machine 150) coupled to the platform 120 via the network 104.

The client devices 102A-N (collectively and individually referred to as client device(s) 102 herein) can include one or more computing devices such as personal computers (PCs), laptops, mobile phones, smart phones, table computers, netbook computers, network-connected televisions, etc. In some implementations, a client device 102 can also be referred to as a “user device.” The client devices 102 can include a content viewer. In some implementations, a content viewer can be an application that provides a user interface (UI) for users to view or upload content, such as a user query. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital media items, digital images, electronic books, etc.). In some implementations, the content viewer can be a code migration application for users to conduct code migration operations on the platform 120. As such, the content viewers can be provided to the client devices 102A-102N by the platform 120.

In some implementations, the platform 120 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a file (e.g., source code of an application) and/or provide the file to the user. For example, the platform 120 can be a code migration platform. The code migration platform may allow a user to request performance of or otherwise initiate code migration operations on code (e.g., source code) stored at the data store 110. The platform 120 can also include a website (e.g., a webpage) or application back-end software that can be used to provide a user with access to the source code 122.

As described above, the platform 120 can detect the user query 124 received by the client devices 102A-N. In some embodiments, an optimized prompt engine 152 of the platform 120 provides a prompt pertaining to the user query 124 as the input to a first AI model 182. The first AI model 182 can be trained to generate a set of prompts for a second AI model 184 based on the user query 124 provided by a user of platform 120 (e.g., via a client device 102). The second AI model 184 can be trained to perform at least one code migration operation on the source code 122 based on the set of prompts generated by the first AI model 182. The second AI model 184 can be further trained to determine an indication of a number of predicted validation errors for a code migration operation to be performed by the second AI model 184 based on each of the set of prompts and select a respective migrated version of the source code that has the lowest number of predicted validation errors as an optimized migrated version of the source code. The second AI model 184 can be trained to perform at least one code migration operation on the source code 122.

A user of platform 120 can access the first AI model 182 and/or the second AI model 184 of predictive system 180 via one or more tools or resources of the platform 120. For example, the platform 120 can provide a client device 102 associated with a user with access to a UI for an application (e.g., a code migration application) that enables a user to request performance of or otherwise initiate code migration operations. The UI can include one or more UI elements that enable the user to engage with the first AI model 182 and/or the second AI model 184 of the predictive system 180 in accordance with the functionality of the code migration application. For instance, the UI can include a UI element that enables a user to provide a request (e.g., user query 124) pertaining to a code migration operation. Upon detecting a user engagement with the UI element (e.g., via a UI of the client device 102), the optimized prompt engine 152 may provide a prompt pertaining to the user query 124 to the predictive system 180. The predictive system 180 can provide the prompt associated with the user query 124 as an input to the first AI model 182 and can obtain an output (e.g., the set of prompts) of the first AI model 182. Each prompt of the set of prompts can include an instruction that causes the first AI model 182 to perform a specific task (e.g., code migration operation) in accordance with the user query 124. In some embodiments, the prompt can include the user query 124 provided by the user and/or can include additional or alternative information associated with the user query 124 provided by the user. The output of the first AI model 182 (e.g., the set of prompts including an optimized prompt) can then be provided to the second AI model 184 as an input to perform code migration operations on the source code 122. The second AI model 184 can then provide an output (e.g., an optimized migrated version of the source code) based on performing code migration operations in accordance with the optimized prompt. The platform 120 can update the UI provided to the client device 102 to include the optimized migrated version of the source code for presentation to the user. It should be noted that embodiments of the present disclosure are not limited to the tasks or functions explicitly described herein and embodiments can be applied to any type of task or function that could be performed by an AI model.

In some embodiments, the first AI model 182 and/or the second AI model 184 can be an AI model that has been trained on a corpus of textual data (e.g., optimized prompts). In some embodiments, the first AI model 182 and/or the second AI model 184 can be a model that is first pre-trained on a corpus of text to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the first AI model 182 and/or the second AI model 184 can then be further trained and/or fine-tuned on organizational data, including proprietary organizational data. The first AI model 182 and/or the second AI model 184 can also be further trained and/or fine-tuned on organizational data associated with a file, including proprietary organizational data associated with a file.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the one or more outputs of the first AI model 182 and/or the second AI model 184 while training may be ranked by a user, according to a variety of factors, including accuracy, helpfulness, veracity, acceptability, or any other metric useful in the fine-tuning portion of training. In this manner, the first AI model 182 and/or the second AI model 184 can learn to favor these and any other factors relevant to users within an organization when generating a response.

In some embodiments, the first AI model 182 and/or the second AI model 184 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into another AI model that has been trained in a similar manner as the “fine-tuned” portion of training above. In such a way, two more AI models may accomplish work similar to one model that has been pre-trained, and then fine-tuned.

In one embodiment, the first AI model 182 and/or the second AI model 184 may be one or more of decision trees, random forests, support vector machines, or other types of machine learning models. In one embodiment, the first AI model 182 and/or the second AI model 184may be one or more artificial neural networks (also referred to simply as a neural network). The artificial neural network may be, for example, a convolutional neural network (CNN), one or more recurrent neural networks (RNNs), or a deep neural network. In one embodiment, processing logic performs supervised machine learning to train the neural network.

As indicated above, the first AI model 182 and/or the second AI model 184 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

It should be noted that although FIG. 1 illustrates the optimized prompt engine 152 as part of the platform 120, in additional or alternative embodiments, one or more portions or components of the optimized prompt engine 152 can reside and/or be executed at the client devices 102. In other or similar embodiments, one or more components of the optimized prompt engine 152 can reside on one or more server machines that are remote from the platform 120. In an illustrative example, the optimized prompt engine 152 can reside at the server machine 150. It should be noted that in some other implementations, the functions of the platform 120, the server machine 150, and/or the predictive system 180 can be provided by more or a fewer number of machines. For example, in some implementations, components and/or modules of the platform 120, the server machine 150, and/or the predictive system 180 may be integrated into a single machine, while in other implementations components and/or modules of any of the platform 120, the server machine 150, and/or the predictive system 180 may be integrated into multiple machines. In addition, in some implementations, components and/or modules of the server machine 150 and/or the predictive system 180 may be integrated into the platform 120.

In general, functions described in implementations as being performed the platform 120, the server machine 150, and/or the predictive system 180 can also be performed on the client devices 102A-N in other implementations. In addition, the functionality attributed to a particular component can be performed by different or multiple components operating together. The platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of the platform 120.

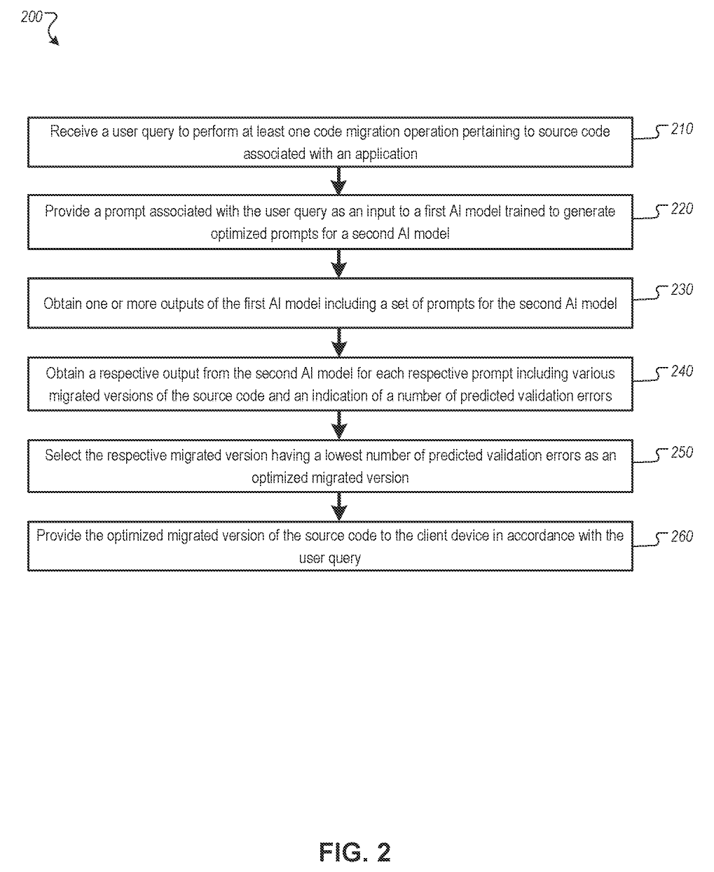

FIG. 2 depicts a flow diagram of an example method 200 for optimizing prompts for large-scale code migration using AI in accordance with implementations of the present disclosure. The method 200 can be performed by processing logic that can include hardware (circuitry, dedicated logic, etc.), software (e.g., instructions run on a processing device), or a combination thereof. In one implementation, some or all the operations of the method 200 can be performed by one or more components of the system architecture 100 of FIG. 1. In some embodiments, some or all of the operations of the method 200 can be performed by the optimized prompt engine 152 of FIG. 1

At block 210, processing logic receives a request to perform at least one code migration operation (e.g., an operation to update an API, an operation to translate a first language of the source code to a second language, an operation to update a language version of the source code, and/or an operation to update a dependency relationship of the source code) pertaining to source code associated with an application. In some embodiments, the platform 120 can receive the request from a client device 102 associated with a user of the platform 120. The request can include or otherwise correspond to a user query 124 (e.g., along with additional or different information). In some implementations, the user query 124 is a natural language query. For purposes of explanation and illustration only, the user query 124 is referred to as being transmitted by the client device 102A associated with a user of the platform 120. However, the user query 124 may be transmitted by any client device 102, in accordance with embodiments described herein.

The client device 102A can transmit the user query 124 to the platform 120 based on a user request associated with one or more functionalities of platform 120. For example, upon receiving a user request to perform at least one code migration operation, the client device 102A can transmit the user query 124 to the platform 120. In other or similar embodiments, client device 102A can transmit the user query 124 to the platform 120 based a detection of a user interaction with one or more UI elements of a UI associated with platform 120. As indicated above, the user query 124 can include an indication of a type of code migration operation of the request and/or data or metadata corresponding to a type of code migration operation of the request. In additional or alternative embodiments, the user query 124 can include contextual data associated with the request. Contextual data can include data that indicates a context associated with the type of code migration operation(s), the file type(s), and/or the particular file(s) of the request. As described above, in some embodiments, the client device 102A can include such contextual data with the user query 124. In other or similar embodiments, the optimized prompt engine 152 can determine the contextual data (e.g., based on historical data associated with the user, the type of code migration operation(s), the file type(s), and/or the particular file(s)).

At block 220, processing logic provides a prompt pertaining to the user query 124 as an input to a first AI model 182 trained to generate optimized prompts for a second AI model 184 trained to perform code migration operations. In some embodiments, the optimized prompt engine 152 can obtain a prompt associated with a code migration operation of user query 124. A prompt refers to an instruction that, when provided as an input to the first AI model 182, causes the first AI model 182 to perform operations to generate a set of prompts (including an optimized prompt) for the second AI model 184 associated with a code migration operation of the user query 124. In some embodiments, the optimized prompt engine 152 can obtain the prompt associated with the optimized prompt based on information of the user query 124.

In some implementations, training the first AI model 182 to obtain the set of prompts for the second AI model 184 includes identifying historical user query data associated with historical code migration operation data, identifying historical prompt data associated with historical code migration operation data, and training the first AI model 182 using data input including the historical user query data and target output including the historical prompt data to generate a trained first AI model 182. In some implementations, training the second AI model 184 to generate an optimized migrated version of the source code includes identifying historical optimized prompt data associated with historical migrated source code data, identifying historical code migration operation data associated with historical migrated source code data, and training the second AI model 184 using data input including the historical optimized prompt data and target output including the historical code migration operation data to generate a trained second AI model 184.

At block 230, processing logic obtains one or more outputs of the first AI model 182. The one or more outputs may include a set of prompts for the second AI model 184. In some implementations, the set of prompts for the second AI model 184 is generated by the trained first AI model 182. For example, this may be done by identifying user query data associated with the at least one code migration operation, providing the user query data as input to the trained first AI model 182, and obtaining, from the trained first AI model 182, output associated with predictive data associated with the set of prompts for the second AI model.

At block 240, processing logic obtains a respective output for each respective prompt of the set of prompts of the one or more outputs of the first AI model 182. The respective output of the second AI model 184 can include a respective migrated version of the source code from various migrated versions of the source code. Each respective migrated version of the source code may include an indication of a number of predicted validation errors for the at least one code migration operation to be performed by the second AI model 184 based on the respective prompt. In some implementations, processing logic obtains the indication of the number of predicted validation errors for each of the various migrated versions. In some implementations, the predicted validation errors are associated with one or more validation functions. The one or more validation functions may include a build function, a build repair function, a unit test function, and/or a unit test repair function.

At block 250, processing logic selects, from the various migrated versions of the source code, the respective migrated version as an optimized migrated version of the source code associated with the respective prompt (e.g., from the first AI model 182) as an optimized prompt. The optimized migrated version is selected by processing logic based on a determination that the respective migrated version has a lowest number of predicted validation errors based on the optimized prompt.

In some implementations, the respective migrated version is selected as the optimized migrated version by determining, by the processing logic, whether the respective prompt is directed to performing the at least one code migration operation for a portion of the source code that has been previously updated based on a prior code migration operation. In this case, the respective migrated version is selected as the optimized migrated version responsive to the processing logic determining that the respective prompt is not directed to performing the at least one code migration operation for the portion of the source code that has been previously updated. In some implementations, the respective migrated version is selected as the optimized migrated version by determining, by the processing logic, that the respective prompt is directed to performing the at least one code migration operation for a first portion of the source code and a second portion of the source code associated with the first portion of the source code via one or more dependencies. In some implementations, generating the optimized migrated version of the source code includes identifying respective prompt data associated with the at least one code migration operation, providing the respective prompt data as input to the trained second AI model 184, and obtaining, output associated with predictive data associated with the optimized migrated version of the source code.

At block 260, processing logic provides the optimized migrated version of the source code to the client device 102A in accordance with the user query 124. The user may verify that the at least one code migration operation has been conducted successfully.

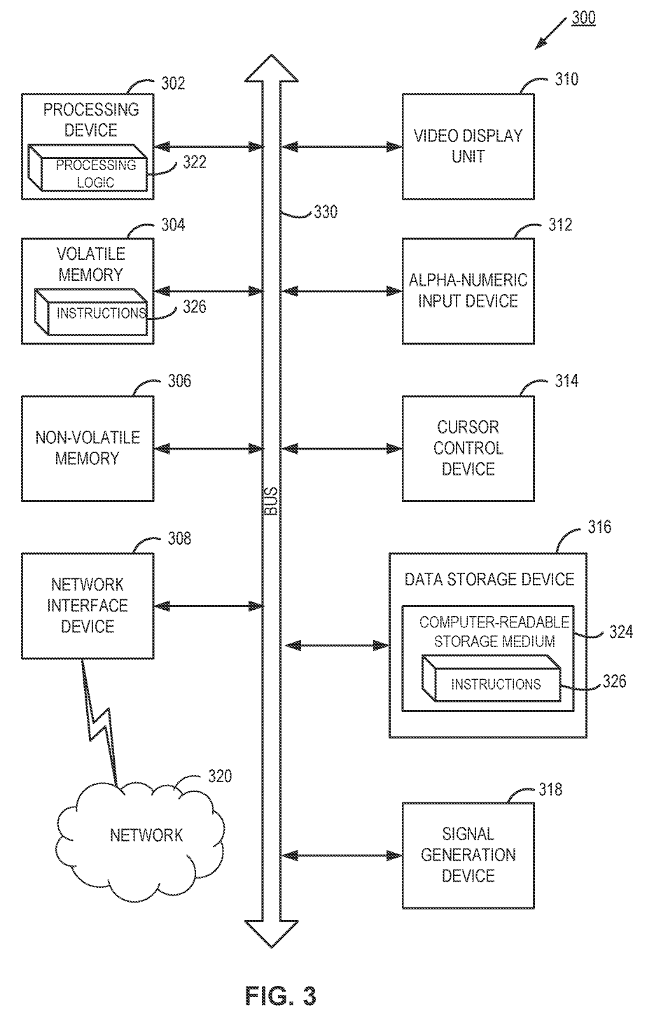

FIG. 3 is a block diagram illustrating an example computer system 300, in accordance with implementations of the present disclosure. In some embodiments, computer system 300 is connected (e.g., via a network, such as a Local Area Network (LAN), an intranet, an extranet, or the Internet) to other computer systems. In some embodiments, computer system 300 operates in the capacity of a server or a client computer in a client-server environment, or as a peer computer in a peer-to-peer or distributed network environment. In some embodiments, computer system 300 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term "computer" shall include any collection of computers that individually or jointly execute a set (or multiple sets) of instructions to perform any one or more of the methods described herein.

In a further aspect, the computer system 300 includes a processing device 302, a volatile memory 304 (e.g., Random Access Memory (RAM)), a non-volatile memory 306 (e.g., Read-Only Memory (ROM) or Electrically-Erasable Programmable ROM (EEPROM)), and a data storage device 316, which communicate with each other via a bus 330.

In some embodiments, processing device 302 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 300 further includes a network interface device 308 (e.g., coupled to network 320). In some embodiments, computer system 300 also includes a video display unit 310 (e.g., an LCD), an alpha-numeric input device 312 (e.g., a keyboard), a cursor control device 314 (e.g., a mouse), and a signal generation device 318.

In some implementations, data storage device 316 includes a non-transitory computer-readable storage medium 324 on which store instructions 326 encoding any one or more of the methods or functions described herein, including instructions for implementing methods described herein.

In some embodiments, instructions 326 also reside, completely or partially, within volatile memory 304 and/or within processing device 302 during execution thereof by computer system 300, hence, in some embodiments, volatile memory 304 and processing device 302 also constitute machine-readable storage media.

While computer-readable storage medium 324 is shown in the illustrative examples as a single medium, the term "computer-readable storage medium" shall include a single medium or multiple media (e.g., a centralized or distributed database, and/or associated caches and servers) that store the one or more sets of executable instructions. The term "computer-readable storage medium" shall also include any tangible medium that is capable of storing or encoding a set of instructions for execution by a computer that cause the computer to perform any one or more of the methods described herein. The term "computer-readable storage medium" shall include, but not be limited to, solid-state memories, optical media, and magnetic media.

In some embodiments, the methods, components, and features described herein are implemented by discrete hardware components or are integrated in the functionality of other hardware components such as ASICS, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “receiving,” “causing,” “training,” “generating,” “providing,” “obtaining,” “interrupting,” “determining,” “transmitting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms "first," "second," "third," "fourth," etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms "first," "second," "third," "fourth," etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ± 10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
a memory; and
a set of one or more processing devices coupled to the memory, wherein the set of one or more processing devices is to perform operations comprising:
receiving, from a client device associated with a user, a user query to perform at least one code migration operation pertaining to source code associated with an application;
providing a prompt associated with the user query as an input to a first artificial intelligence (AI) model, wherein the first AI model is trained to generate optimized prompts for a second AI model to perform code migration operations;
obtaining one or more outputs of the first AI model, wherein the one or more outputs comprise a plurality of prompts for the second AI model;
obtaining, for each respective prompt of the plurality of prompts of the one or more outputs of the first AI model, a respective output from a plurality of outputs of the second AI model, wherein the respective output of the second AI model comprises a respective migrated version of the source code from a plurality of migrated versions of the source code and, for each respective migrated version of the source code, an indication of a number of predicted validation errors for the at least one code migration operation performed by the second AI model based on the respective prompt,
selecting, from the plurality of migrated versions of the source code, the respective migrated version of the source code as an optimized migrated version of the source code associated with the respective prompt as an optimized prompt based on a determination that the respective migrated version has a lowest number of predicted validation errors based on the optimized prompt; and
providing the optimized migrated version of the source code to the client device in accordance with the user query.

2. The system of claim 1, wherein the operations comprising selecting the respective migrated version of the source code as the optimized migrated version of the source code further comprises:
determining whether the respective prompt is directed to performing the at least one code migration operation for a portion of the source code that has been previously updated based on a prior code migration operation,
wherein the respective migrated version of the source code is selected as the optimized migrated version of the source code responsive to a determination that the respective prompt is not directed to performing the at least one code migration operation for the portion of the source code that has been previously updated.

3. The system of claim 1, wherein the operations comprising selecting the respective migrated version of the source code as the optimized migrated version of the source code further comprises:
determining that the respective prompt is directed to performing the at least one code migration operation for a first portion of the source code and a second portion of the source code, wherein the second portion of the source code is associated with the first portion of the source code via one or more dependencies.

4. The system of claim 1, wherein the predicted validation errors are associated with one or more validation functions comprising at least one of a build function, a build repair function, a unit test function, or a unit test repair function.

5. The system of claim 1, wherein the user query further comprises:
a file type, wherein the at least one code migration operation is to be performed on the file type.

6. The system of claim 1, wherein the user query further comprises:
a particular file, wherein the at least one code migration operation is to be performed on the particular file.

7. The system of claim 1, wherein the operations further comprise:
identifying historical user query data associated with historical code migration operation data;
identifying historical prompt data associated with historical code migration operation data; and
training the first AI model using data input comprising the historical user query data and target output comprising the historical prompt data to generate a trained first AI model, wherein the obtaining the plurality of prompts for the second AI model is associated with the trained first AI model.

8. The system of claim 1, wherein the operations comprising obtaining the plurality of prompts for the second AI model further comprises:
identifying user query data associated with the at least one code migration operation;
providing the user query data as input to a trained first AI model; and
obtaining, from the trained first AI model, output associated with predictive data associated with the plurality of prompts for the second AI model.

9. The system of claim 1, wherein the operations further comprise:
identifying historical optimized prompt data associated with historical migrated source code data;
identifying historical code migration operation data associated with historical migrated source code data; and
training the second AI model using data input comprising the historical optimized prompt data and target output comprising the historical code migration operation data to generate a trained second AI model, wherein obtaining the optimized migrated version of the source code is associated with the trained second AI model.

10. The system of claim 1, wherein operations comprising obtaining the optimized migrated version of the source code further comprises:
identifying respective prompt data associated with the at least one code migration operation;
providing the respective prompt data as input to a trained second AI model; and
obtaining, from the trained second AI model, output associated with predictive data associated with the optimized migrated version of the source code.

11. The system of claim 1, wherein the at least one code migration operation comprises at least one of:
an operation to update an application programming interface (API);
an operation to translate a first language of the source code to a second language;
an operation to update a language version of the source code; or
an operation to update a dependency relationship of the source code.
